(19) United States
(12) Patent Application Publication
(10) Pub. No.: US 2009/0031600 A1
(43) Pub. Date: Feb. 5, 2009

(54) Bicycle mobile advertising system and method

(76) Inventors: Thomas F. Anderson, II, Seneca, SC (US); Paul B. Anderson, Seneca, SC (US)

Correspondence Address: JACOBSON HOLMAN PLLC, 400 SEVENTH STREET N.W., SUITE 600, WASHINGTON, DC, 20004, US

(21) Appl. No.: 12/219,728

(22) Filed: Jul. 28, 2008

Related U.S. Application Data
(60) Provisional application No. 60/935,176, filed on Jul. 30, 2007.

(51) Int. Cl. G09F 21/04

(52) U.S. Cl. 40/606.03; 40/607.01

(57) ABSTRACT

A bicycle-mounted sign holder with interchangeable sign capability for the purpose of advertising goods and services as displayed on the sign. The sign holder includes a pole and a sign frame secured to an upper end of the pole. The lower end of the pole is mounted on the bicycle and has a length sufficient to elevate the sign frame to a height that is above the rider's head when the bicycle is being ridden. The frame is coupled to the pole with a pivoting device so that the frame can swivel around the pole as moved by the wind. A sign displaying advertising material is secured to the frame and is then broadcast over a given geographical area as the bicycle is ridden through the area.

This application is entitled to and hereby claims the priority of co-pending U.S. Provisional application, Ser. No. 60/935,176 filed Jul. 30, 2007.

### BACKGROUND OF THE INVENTION

1. Field of the Invention

The present invention is related to the field of advertising and, more particularly, to a system and method for distributing advertisements on a mobile basis using a bicycle or other two-wheeled vehicle.

2. Description of the Related Art

Various systems and methods exist for placing advertisements on cars and trucks in order to capitalize on their mobility to increase the visibility of the advertised products and services. Representative systems and methods are set forth in U.S. Pat. Nos. 7,287,349, 6,898,517, 6,404,519, and 5,974,711.

Bicycles and other two-wheeled vehicles have also been used to promote products and services through placement of advertising material on the vehicle's frame and/or wheels. For example, U.S. Patent Application Publication No. US 2005/0144823 discloses advertising on the wheel area of a racing sulky by adding a non-rotating sign which is concentric with the wheels. Similarly, U.S. Patent Publication No. US 2006/0005440 discloses using both the frame and the wheels of a bicycle, with lettering placed on the frame and also on a non-rotating disc placed concentrically with the bicycle wheel so as to be readable when the bike is in motion. In these and other prior art systems, however, the advertising is only visible when the two-wheeled vehicle is in an open area so that the advertisement is not obscured by other vehicles or objects positioned or moving alongside the advertising vehicle.

### SUMMARY OF THE INVENTION

In view of the foregoing, one object of the present invention is to overcome the difficulties of lost or limited visibility when advertising in a congested area using a bicycle or other two-wheeled vehicle.

Another object of the present invention is to provide a mobile advertising system and method using a bicycle that can be safely operated in crowded areas while maintaining excellent advertisement visibility.

A further object of the present invention is to provide a mobile advertising system and method using a bicycle to display advertising on a sign that can be easily and quickly changed to provide multiple advertisement distribution in a desired area in a limited time frame such as over the duration of a sporting event.

Yet another object of the present invention is to provide a mobile advertising system and method using a bicycle to display advertising on a sign that allows the sign to rotate to ensure bike stability and rider safety in windy conditions.

A still further object of the invention is to provide an advertising method that is highly adaptable and easily deployed to meet changing environments and which can be implemented at low cost while both efficiently and effectively reaching the public with an advertiser's products and services.

In accordance with these and other objects, the present invention is directed to a bicycle-mounted sign holder with interchangeable sign capability for the purpose of advertising goods and services as displayed on the sign. The sign holder includes a pole and a sign frame secured to an upper end of the pole. The lower end of the pole is mounted on the frame of the bicycle or other two-wheeled vehicle and has a length sufficient to elevate the sign frame to a height that is above the rider's head when the bicycle is being ridden. The frame is coupled to the pole with a pivoting device so that the frame can swivel around the pole as moved by the wind. A sign displaying advertising material is secured to the frame and is then broadcast over a given geographical area as the bicycle is ridden through the area. The bicycle-mounted sign provides advertisers with a mobile way of reaching consumers in a broad spectrum of environments including both traditional and non-traditional advertising venues.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a bicycle equipped with an elevated sign in accordance with the present invention.

FIG. 2 shows a more detailed view of the sign frame and sign of FIG. 1.

FIG. 3 is a view taken along line A-A of FIG. 2.

FIG. 4 is a more detailed view of the fastening element as attached to the sign frame in accordance with the present invention.

FIG. 5 is a cross section of one of the frame pieces used in the sign frame of FIG. 2.

FIG. 6 illustrates another sign frame embodiment in accordance with the present invention.

FIG. 7 is a cross sectional view taken along line B-B of FIG. 6.

FIG. 8 is a top view taken along line C-C of FIG. 6.

FIG. 9 illustrates yet another sign frame embodiment with a flexible sign in accordance with the present invention.

FIG. 10 depicts the sign and sign frame of FIG. 9 when the flexible sign has been blown sideways to become free of the bottom piece of the frame.

FIG. 11 is partial view of the flexible sign of FIG. 9 showing the stiffening member.

FIG. 12 is a photograph showing the base of the pole as mounted on a luggage carrier and stabilized with support cables in accordance with the present invention.

FIG. 13 is another embodiment of a bicycle equipped with an elevated sign in accordance with the present invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

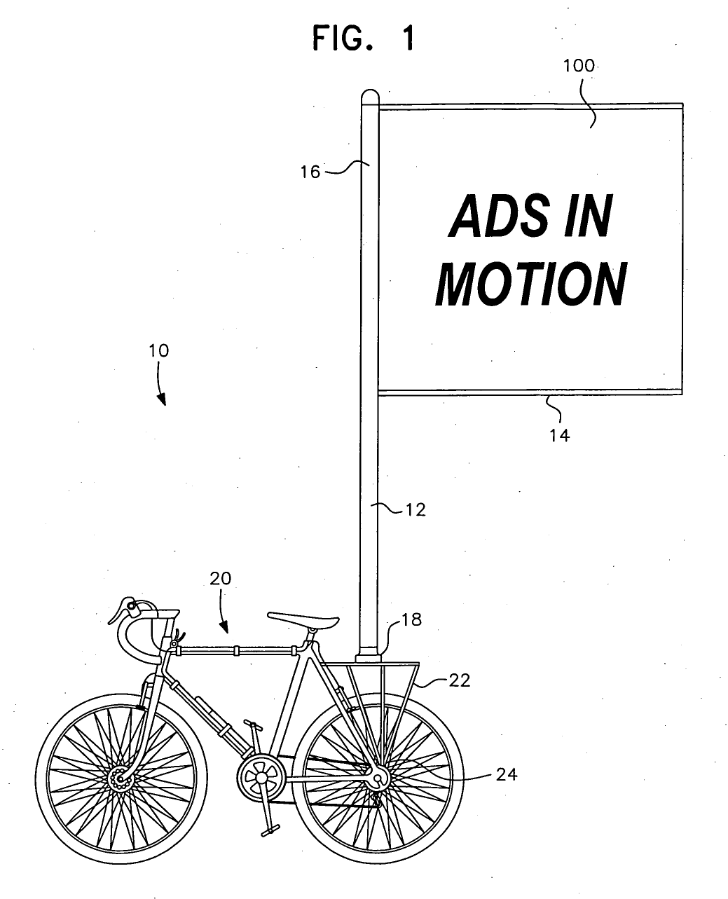

As illustrated in FIG. 1, the present invention is directed to a bicycle-mounted sign holder generally designated by the reference numeral 10. The sign holder includes a pole 12 and a sign frame 14 secured to an upper end 16 of the pole 12. A sign 100 is mounted in the frame 14.

The pole is an elongated member having sufficient flexibility to withstand wind pressures while being sufficiently rigid to hold the sign frame in an essential vertical orientation. According to a preferred embodiment, the pole is constructed of PVC pipe although other materials could be used that provide some degree of flexibility including wood, metal, various plastics, composite materials such as those used in making fishing rods, etc.

The lower end 18 of the pole is mounted to the frame of the bicycle, generally designated by the reference numeral 20, directly or to a separate component mounted on the bike for this purpose. As shown in FIG. 1, the pole is preferably mounted on a supporting structure 22 so as to be vertically aligned with the rear sprocket 24 of the bike 20 for balanced load bearing. This supporting structure may be embodied using a modified bike luggage rack if appropriate. Other supporting structure and connecting mechanisms or fasteners of conventional design could also be used as would be known by persons of ordinary skill in the art.

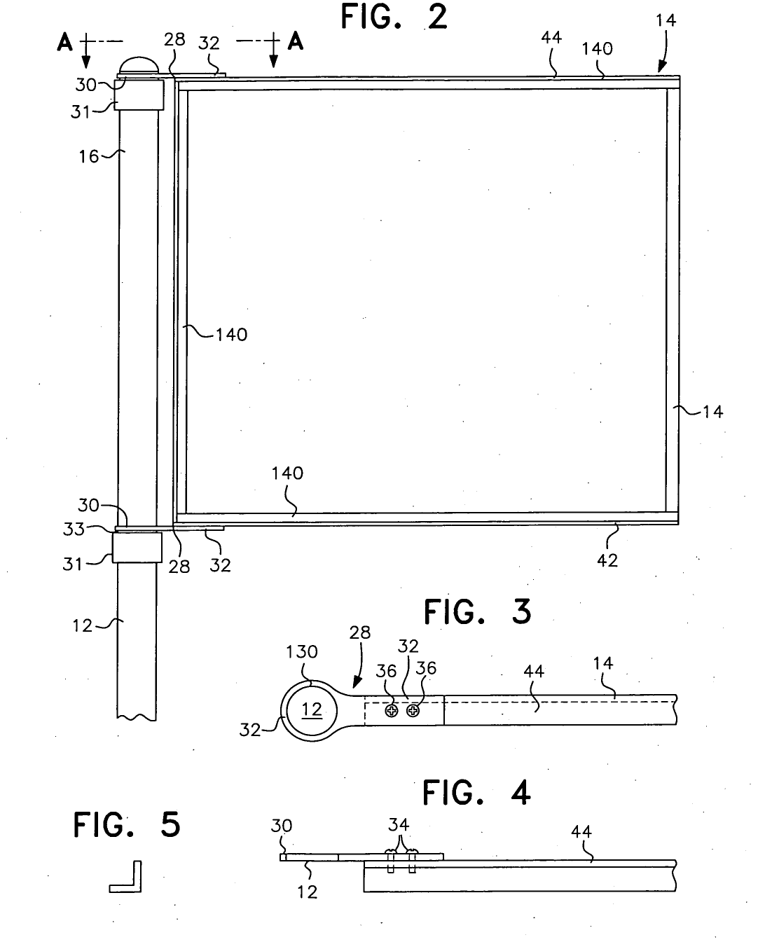

As shown in FIG. 2, the upper end 16 of the pole is provided with a pair of pivoting fasteners 28 mounted so as to be able to swivel 360 degrees around the circumference of the pole as moved by the wind or other external force. The pivoting fasteners 28 may be embodied as any kind of swiveling fastener, turn-buckle, or other comparable fastener, as would be known by persons of ordinary skill in the art.

In the embodiment shown in FIGS. 2-4, the pivoting fastener has a swiveling portion 30 with a generally circular opening 32 through which the pole 12 extends (see FIG. 3). The swiveling portion 30 is integral with a bearing arm 32 that is secured to the sign frame using bolts 34, screws or any other suitable fastening element, as shown in FIG. 4. The bolts 34 pass through apertures 36 in the bearing arm 32.

The sign frame is secured to the pole using the pivoting fasteners which slide over the pole as shown. The pole is preferably constructed in several pieces connected by PVC connectors 31 which are positioned to provide a bearing surface 33 to support the swiveling portion. Once secured, the sign frame is held in a generally vertical orientation, and extends horizontally outward from the pole. Through the pivoting fasteners, the frame is free to rotate around the pole while retaining its generally vertical orientation so that the sign remains fully visible from at least two aspects even if those aspects do not correspond with the sides of the bicycle.

The frame preferably includes four side pieces 140, although sign frames having fewer or more side pieces could also be used if designed appropriately in view of the signs to be mounted therein. The side pieces may be made of any lightweight metal such as aluminum, wood, molded plastic, PVC, composite materials, etc.

According to a preferred embodiment, the sign frame includes a bottom piece 42 and a top piece 44 of aluminum or other lightweight metal, constructed to have an angle as shown in FIG. 5. The top and bottom pieces are secured to one another via respective side pieces, which may also have an angled configuration, to form a generally rectangular frame. The sign is secured in the frame by bolts, screws or any other appropriate fastening elements that can be used to secure the sign to the frame material.

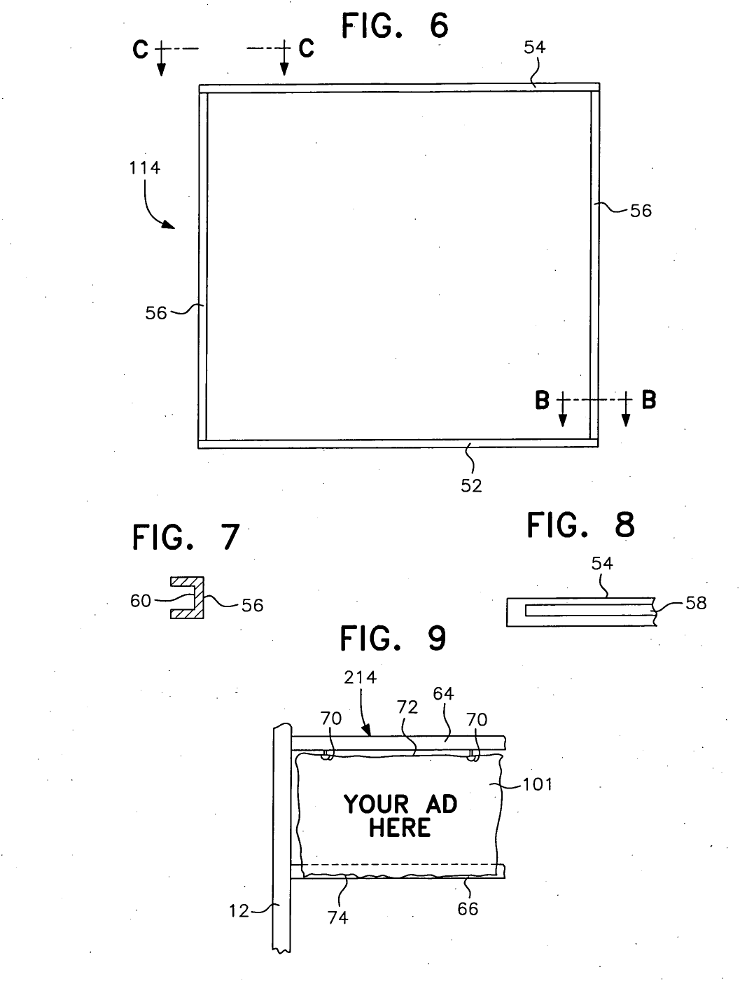

According to another preferred embodiment shown in FIGS. 6-8, the sign frame includes a bottom piece 52, a top piece 54 and at least two side pieces 56 having a C-channel configuration (see FIG. 7). These four pieces are secured to one another at their respective ends to form a generally rectangular frame 114. The bottom piece 52 may also be constructed with a C-channel configuration, or can have a flat construction. The top piece 54 joins and stabilizes the two side pieces 56 and has an open upper edge 58 (see FIG. 8) to allow a sign to be inserted through the top piece and between the side pieces along the channels 60 formed by the C-channel configuration. Once inserted, the bottom of the sign rests on the bottom piece, either on the flat surface thereof or within the C-channel if made with that configuration.

Alternatively, the sign frame could be constructed without an upper piece, provided the connection between the lower ends of the side pieces and the bottom piece, and the material of the side and bottom pieces themselves, is sufficiently rigid to adequately support the sign without undue flexing when the bicycle is in motion.

The sign frame can also be constructed of PVC pipe or wood with the side pieces having an angled configuration or a channel cut therein to secure the side edges of the sign.

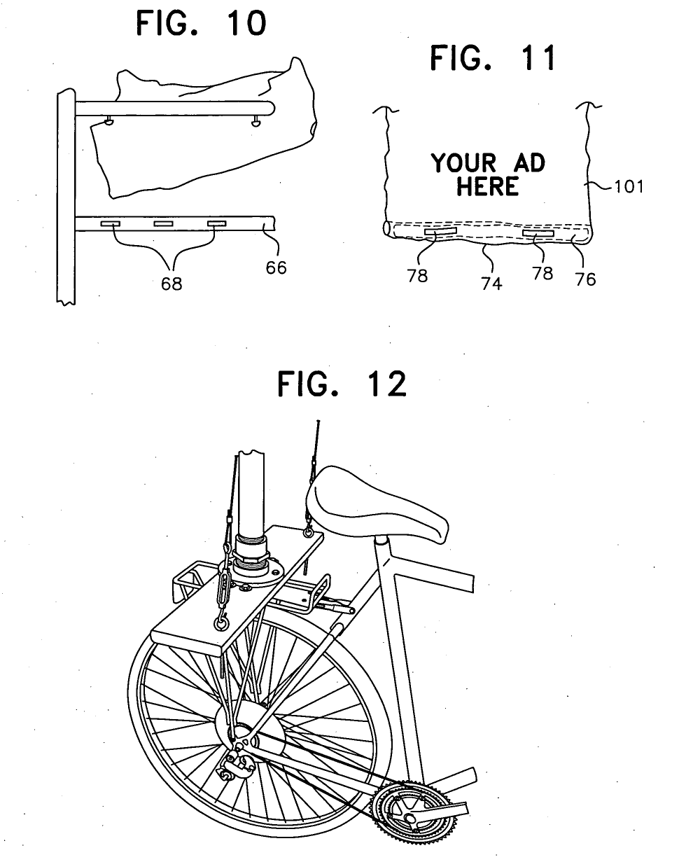

In a further embodiment as shown in FIGS. 9-11, the signs 101 can be made of flexible material such as heavyweight cloth or a thin sheet of plastic material that can flex and twist without breaking. In this case, the frame 214 may be made to include an upper bar 64 and a lower bar 66, each extending in a generally horizontal orientation from the pole. At least one magnetic member 68 is mounted on the lower bar. Side pieces may or may not be provided. The sign 101 is connected to the upper bar 64 by fasteners 70, such as by lacing, clip fasteners, cable ties, etc., so that the upper edge 72 is held securely but somewhat flexibly against the upper bar 64. The lower edge 74 of the sign 101 is provided with a stiffening member 76 (see FIG. 11) having a magnetic member 78 positioned to align with the magnetic member 68 on the lower bar 66. During calm weather conditions, the magnetic connection between the two magnetic members will retain the sign in a relatively taut vertical orientation extending between the upper and lower bars, as shown in FIG. 9. Should windy conditions arise, however, the strength of the magnetic members 68, 78 is not sufficient to hold the lower edge 74 of the sign, allowing it to break free and flap out of the frame, as shown in FIG. 11. This ensures that the cyclist is not subjected to dangerous crosswind forces that could tip the bike over. When the wind subsides, the weight of the stiffening member will naturally return the lower edge of the sign to a position adjacent the lower bar where the magnetic members will again reengage to return the sign to its vertical orientation. With this embodiment, the frame does not have to be pivotally attached to the pole, although it could be.

The pole has a length sufficient to elevate the sign frame to a height that is above the rider's head when the bicycle is being ridden, i.e., on the order of about 8-13 feet above the ground. This can be accomplished using a single elongated member or through the use of a telescoping pole or a pole with foldable portions. A pole that includes two or more separable components that are screwed or otherwise connected in series with one another could also be used. Any pole construction is intended to fall within the scope of the invention as would be understood by persons of ordinary skill in the art.

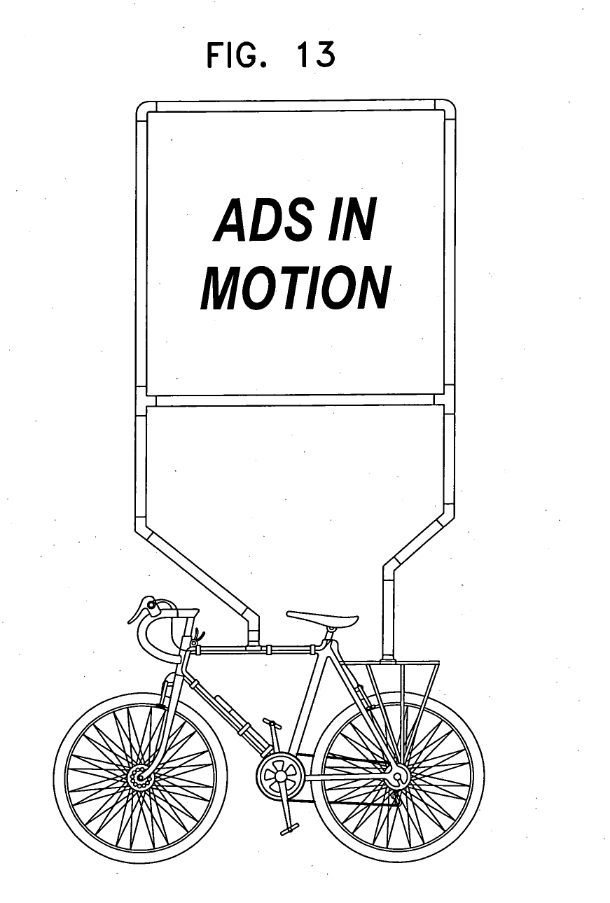

To provide vertical stability to the pole, support cables may advantageously be extended from the upper portion of the pole to spaced mounting positions on opposite sides of the base of the pole as shown in FIG. 12.

A further embodiment of the bicycle-mounted sign system and method is depicted in FIG. 13. In this embodiment, the sign is positioned for display over the rider's head. This embodiment works well with a flexible sign such as that discussed in connection with FIGS. 9-11.

Other embodiments in which the pole and one or more sign frames are used to support multiple signs are also envisioned. In any of these embodiments, a sign displaying advertising material is secured to or within the frame and is then “broadcast” over a given geographical area as the bicycle is ridden through the area. The high positioning of the sign produces excellent visibility regardless of the presence of people, other vehicles, etc. immediately adjacent the bike. As a result, this form of advertising may be advantageously used in crowded areas such as parking lots surrounding stadiums in which sporting events such as football games are underway. As is known, these parking lots serve as the venue for tailgate parties in which spectators are gathered to enjoy themselves and the festivities, along with the game. The bicycle-mounted sign provides advertisers with a mobile way of reaching these consumers in an eye-catching and memorable way, thus capitalizing on the previously inaccessible opportunities afforded by these non-traditional advertising venues. The same can be said for a broad spectrum of environments including theme parks, beach boardwalks, park and resort areas where fixed signs and/or motorized vehicles are restricted or prohibited, etc.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. For example, the frame-mounted sign could be mounted on any two-wheeled vehicle, including motorized vehicles such as scooters or mopeds. The frame-mounted sign can also be effectively mounted on small vehicles that have more than two wheels such as tricycles and 4-wheel or quad cycles, or even on golf carts. In these or other alternate configurations, the pole supporting the sign frame can be advantageously mounted on the canopy or roof of the tricycle, quad cycle or golf cart, if the vehicle is equipped with such a structure. Alternatively, the pole and sign may be mounted to the floorboard, as appropriate. Therefore, it is not desired to limit the invention to the specific examples disclosed or the exact construction and operation shown and described. Rather, all suitable modifications and equivalents may be resorted to, falling within the scope of the invention.

What is claimed is:

1. A mobile advertising system comprising:
a wheeled vehicle configured to be at least partly powered by physical energy generated by a person riding said vehicle;
an advertising medium mounted to said vehicle and displayed at a height such that substantially all of said advertising medium is above the person riding said vehicle.

2. The mobile advertising system as set forth in claim 1, wherein the wheeled vehicle is a bicycle and the advertising medium includes a generally planar sign with information presented thereon.

3. The mobile advertising system as set forth in claim 2, wherein said sign is supported on a pole having a substantially vertical orientation, a lower end of the pole being mounted to a frame of said bicycle.

4. The mobile advertising system as set forth in claim 3, wherein said pole is rotatable around its longitudinal axis.

5. The mobile advertising system as set forth in claim 3, wherein an upper end of said pole supports at least one frame member extending generally horizontally from said pole, said sign being secured to said frame member.

6. The mobile advertising system as set forth in claim 5, wherein said frame member is rotatably mounted on said pole.

7. The mobile advertising system as set forth in claim 3, wherein an upper end of said pole supports upper and lower frame members spaced vertically from one another and extending generally horizontally from said pole, said sign being secured between said frame members.

8. The mobile advertising system as set forth in claim 7, wherein said frame members are rotatably mounted on said pole.

9. The mobile advertising system as set forth in claim 3, wherein said sign is rotationally moveable around said pole.

10. The mobile advertising system as set forth in claim 1, wherein the wheeled vehicle has pedals turned by the rider.

11. A mobile advertising system comprising:
a vehicle configured for a person to ride having only two wheels that are arranged one behind the other and in alignment with each other when the vehicle is being ridden;
an advertising medium mounted to said vehicle and displayed at a height such that substantially all of said advertising medium is above the person riding said vehicle.

12. The mobile advertising system as set forth in claim 1, wherein the advertising medium includes a generally planar sign with information presented thereon.

13. The mobile advertising system as set forth in claim 12, wherein said sign is supported on a pole having a substantially vertical orientation, a lower end of the pole being mounted to a frame of said vehicle.

14. The mobile advertising system as set forth in claim 13, wherein an upper end of said pole supports at least one frame member extending generally horizontally from said pole, said sign being secured to said frame member.

15. The mobile advertising system as set forth in claim 14, wherein said frame member is rotatably mounted on said pole.

16. The mobile advertising system as set forth in claim 13, wherein an upper end of said pole supports upper and lower frame members spaced vertically from one another and extending generally horizontally from said pole, said sign being secured between said frame members.

17. The mobile advertising system as set forth in claim 16, wherein said frame members are rotatably mounted on said pole.

18. The mobile advertising system as set forth in claim 13, wherein said sign is rotationally moveable around said pole.

19. The mobile advertising system as set forth in claim 13, wherein said vehicle has pedals which are turned by the rider to at least partly power forward movement of the vehicle.

20. A method of advertising using a vehicle having only two wheels arranged one behind the other and in alignment with each other when the vehicle is being ridden, the method comprising the steps of:
securing a generally vertical support member to the vehicle;
affixing a generally planar member to an upper part of said support member, said generally planar member configured to display textual and/or graphic information so that, when said vehicle is being ridden, said generally planar member is displayed at a height such that substantially all of said textual and/or graphic information is higher than the head of a person riding said vehicle; and
riding said vehicle while said textual and/or graphic information is displayed at said height and moves with said vehicle as it is ridden.
